(19) United States
(12) Patent Application Publication
(10) Pub. No.: US 2013/0135286 A1
(43) Pub. Date: May 30, 2013

(54) DISPLAY METHOD, DISPLAY APPARATUS, AND ELECTRONIC TERMINAL

(71) Applicants: BEIJING LENOVO SOFTWARE LTD., Beijing (CN); LENOVO (BEIJING) CO., LTD., Beijing (CN)

(72) Inventors: Xin LI, Beijing (CN); Lei Zhao, Beijing (CN)

(73) Assignees: LENOVO (BEIJING) CO., LTD., Beijing (CN); BEIJING LENOVO SOFTWARE LTD., Beijing (CN)

(21) Appl. No.: 13/687,902

(22) Filed: Nov. 28, 2012

(30) Foreign Application Priority Data
Nov. 28, 2011 (CN) CN201110385141.6

(51) Int. Cl. G09G 5/00

(52) U.S. Cl. CPC G09G 5/006
USPC 345/214

(57) ABSTRACT

A display method, a display apparatus, and an electronic terminal are disclosed. The electronic terminal comprises a display unit; the method comprises: detecting a first operation, when a display object is displayed along a first display direction at a first display position of the display unit; determining a second display position according to the first operation, when the first operation is a predefined operation, whereat the second display position is different from the first display position; acquiring a correspondence relationship between the display positions and the display directions; determining a second display direction corresponding to the second display position, based on the correspondence relationship between the display positions and the display directions as well as the second display position; and displaying the display object along the second display direction at the second display position.

This application claims priority to CN 201110385141.6 filed on Nov. 28, 2011, the entire contents of which is incorporated herein by reference.

The present invention relates to the field of computer technology, particularly relates to a display method, a display apparatus and an electronic terminal.

### BACKGROUND

In the prior art, when a first user shares a file, for example an picture, with a second user in a same display interface by moving the position of the picture toward the location of the second user, the picture is only changed in its position, while its direction of display is not changed; for example, with reference to FIG. 1, FIG. 1 is a schematic diagram of displaying a same picture in the prior art.

As shown in FIG. 1, an picture 101 is displayed on the display unit 10; when the picture is displayed in a first position (broken line portion), a first user sees a positive direction of the picture 101, i.e. the bottom of the picture 101 is close to a first edge; when the first user wants to share the picture 101 to a second user, he/she can move the picture 101 from the first position to a second position (solid line portion), but the picture 101 is only changed in its position, while its direction of display is not changed, that is, the bottom of the picture 101 is still close to the first edge, and the top is still close to an edge opposite to the first edge; so, in this case, when the second user who locates at an edge perpendicular to the first edge sees the picture 101, he/she sees a side of the picture 101, therefore, it is not convenient for the second user to watch, which causes an uncomfortable user-experience.

Further, if in the above case, when the second user needs to see, the first user or the second user has to rotate the picture through a rotating operation or through a very complex gesture, so that the picture is rotated and moved, which brings inconvenience and uncomfortable user-experience to the users.

### SUMMARY

The present invention provides a display method, a display apparatus and an electronic terminal, to solve the problem in the prior art that a file can not be displayed from an optimum direction.

According to one aspect of the present invention, there is provided a display method applied in an electronic terminal comprising a display unit, and the method comprises: detecting a first operation, when a display object is displayed in a first display direction in a first display position of the display unit; determining a second display position according to the first operation, when the first operation is a predefined operation, wherein the second display position is different from the first display position; acquiring a correspondence relationship between the display positions and the display directions; determining a second display direction corresponding to the second display position, based on the correspondence relationship between the display positions and the display directions as well as the second display position; and displaying the display object in the second display direction in the second display position.

Preferably, the display unit comprises at least a first display region and a second display region, and the first display region and the second display region do not overlap; wherein, all display positions in the first display region correspond to the first display direction; all display positions in the second display region correspond to the second display direction; the first display direction is different from the second display direction.

Preferably, determining a second display position according to the first operation when the first operation is a predefined operation comprises: determining a second display position according to absolute-position parameters, when the first operation is a predefined operation and the first operation comprises absolute-position parameters.

Preferably, determining a second display position according to the first operation when the first operation is a predefined operation comprises: determining a second display position according to the first display position and relative-position parameters, when the first operation is a predefined operation and the first operation comprises relative-position parameters.

Preferably, the second display position is located in an edge region corresponding to an edge of the display unit, wherein the edge region is a region consisting of that edge and a straight line or an arc where a reference pixel of the display unit exists, and wherein a vertical distance from the reference pixel to that edge is equal to a predefined threshold value, and the vertical distances from all pixels in the edge region to that edge is less than or equal to the predefined threshold value.

Preferably, when the second display position is located within the edge region, the second display direction is a direction radiating from the center of the display unit to the edge region.

Preferably, whether or not the second display position is located within the edge region, is judged by the following steps: determining a pixel where the first operation last stops on the display unit, based on the first operation; calculating the vertical distance values from the pixel to each of the edges of the display unit, and obtaining a number N of distance values, where N is an integer equal to or greater than 3; comparing the number N of distance values, and obtaining a minimum distance value in the number N of distance values; judging whether or not the minimum distance value is less than the predefined threshold value; and determining that the second display position is the edge region of the edge corresponding to the minimum distance value, when the minimum distance value is less than the predefined threshold value.

Preferably, the second display position is different from the first display position, which specifically is: the corresponding coordinates of the vertices of the display object in the first display position and in the second display position are different.

According to another aspect of the present invention, there is provided a display apparatus applied in an electronic terminal comprising a display unit, and the display apparatus comprises: a detection module, used for detecting a first operation, when a display object is displayed in a first display direction in a first display position of the display unit; a first determination module, used for determining a second display position according to the first operation, when the first operation is a predefined operation, wherein the second display position is different from the first display position; an acquisition module, used for acquiring a correspondence relationship between the display positions and the display directions; a second determination module, used for determining a second display direction corresponding to the second display position, based on the correspondence relationship between the display positions and the display directions as well as the second display position; and a display module, used for displaying the display object in the second display direction in the second display position.

Preferably, the display unit comprises at least a first display region and a second display region, and the first display region and the second display region do not overlap; wherein, all display positions in the first display region correspond to the first display direction; all display positions in the second display region correspond to the second display direction; the first display direction is different from the second display direction.

Preferably, the first determination module is also used for: determining a second display position according to absolute-position parameters, when the first operation is a predefined operation and the first operation comprises absolute-position parameters.

Preferably, the first determination module is also used for: determining a second display position according to the first display position and relative-position parameters, when the first operation is a predefined operation and the first operation comprises relative-position parameters.

Preferably, the second display position is located in an edge region corresponding to an edge of the display unit, wherein the edge region is a region consisting of that edge and a straight line or an arc where a reference pixel of the display unit exists, and wherein a vertical distance from the reference pixel to that edge is equal to a predefined threshold value, and the vertical distances from all pixels in the edge region to that edge is less than or equal to the predefined threshold value.

Preferably, when the second display position is located within the edge region, the second determination module is also used for: determining that the second display direction is a direction radiating from the center of the display unit to the edge region.

Preferably, the first determination module is also used for judging whether or not the second display position is located within the edge region, the first determination module comprising: a first determination unit, used for determining a pixel where the first operation last stops on the display unit, based on the first operation; a calculation unit, used for calculating the vertical distance values from the pixel to each of the edges of the display unit, and obtaining a number N of distance values, where N is an integer equal to or greater than 3; a comparison unit, used for comparing the number N of distance values, and obtaining a minimum distance value in the number N of distance values; a judgment unit, used for judging whether or not the minimum distance value is less than the predefined threshold value; and a second determination unit, used for determining that the second display position is the edge region of the edge corresponding to the minimum distance value, when the minimum distance value is less than the predefined threshold value.

Preferably, the second display position is different from the first display position, which specifically is: the corresponding coordinates of the vertices of the display object in the first display position and in the second display position are different.

According to another aspect of the present invention, there is further provided an electronic terminal, comprising: a display unit; a motherboard, electrically connected with the display unit; a first processing chip, provided on the motherboard, and used for detecting a first operation, when a display object is displayed in a first display direction in a first display position of the display unit; a second processing chip, provided on the motherboard, and used for determining a second display position according to the first operation, when the first operation is a predefined operation, wherein the second display position is different from the first display position; a third processing chip, provided on the motherboard, and used for acquiring a correspondence relationship between the display positions and the display directions; a fourth processing chip, used for determining a second display direction corresponding to the second display position, based on the correspondence relationship between the display positions and the display directions as well as the second display position; and a fifth processing chip, used for displaying the display object in the second display direction in the second display position; wherein, any two chips from the first processing chip, the second processing chip, the third processing chip, the fourth processing chip and the fifth processing chip, are the same chips or mutually-independent chips.

Beneficial effects of the present invention are as follows:

An embodiment of the present invention adopts a method of determining a corresponding display direction depending on different display positions, so that users who locate in different directions can watch a display object from a comfortable viewpoint.

Further, an embodiment of the present invention sets as follows: a display object is displayed in a same display direction when it is in a fixed region, and in different display directions when it is in different regions, so that users who locate in different regions or directions can watch the display object conveniently.

Furthermore, in an embodiment of the present invention, when a display object is moved to an edge region of the display unit, its display direction will be switched automatically to a display direction adapted to a corresponding edge of that edge region, namely, a direction radiating from the center of the display unit to that edge region, so that users who locate on each edge can watch the display object from an optimum angle.

### BRIEF DESCRIPTION OF THE DRAWINGS

FIG. 1 is a schematic diagram of displaying a same picture in the prior art;

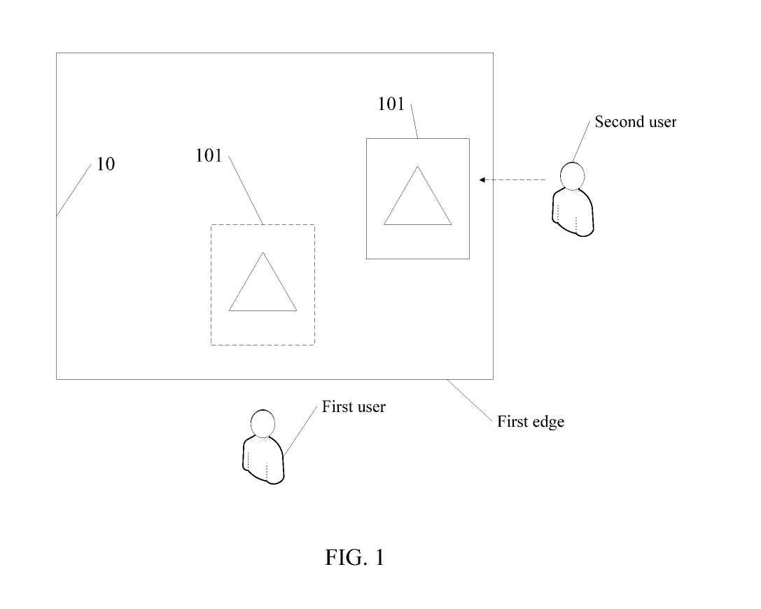

FIG. 2 is a flowchart of a display method in accordance with an embodiment of the present invention;

FIG. 3 is a schematic diagram showing a correspondence relationship between a display object and display directions in a first embodiment of the present invention;

FIG. 4 is a schematic diagram showing a correspondence relationship between a display object and display directions in a second embodiment of the present invention;

FIG. 5 is a schematic diagram of an edge region in an embodiment of the present invention;

FIG. 6 is a schematic diagram of determining that a second display position is located in an edge region in accordance with an embodiment of the present invention;

FIG. 7 is a block diagram illustrating functions of a display apparatus in accordance with an embodiment of the present invention;

FIG. 8 is a detailed functional block diagram of a module in FIG. 7;

FIG. 9 is an architectural diagram of an electronic terminal in accordance with an embodiment of the present invention.

### DETAILED DESCRIPTION OF THE PREFERRED EMBODIMENTS

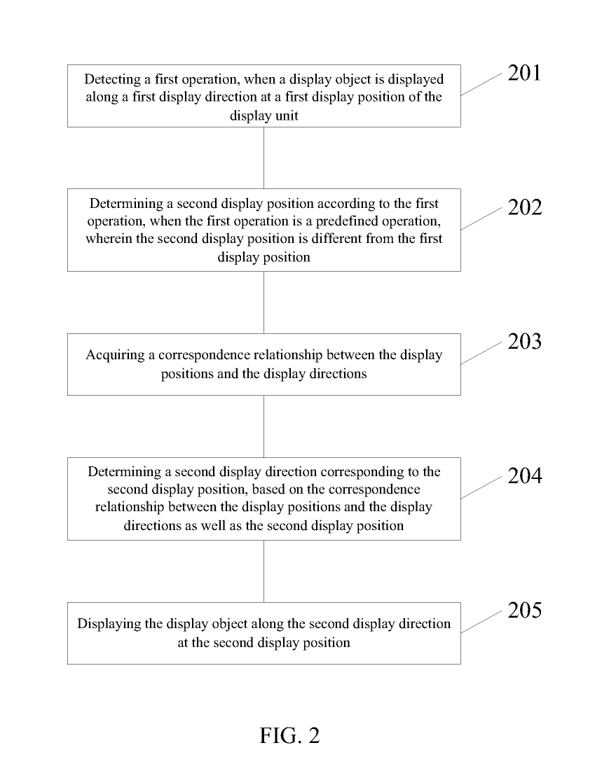

The first embodiment of the present invention provides a display method, and the display method is applied to an electronic terminal comprising a display unit. With reference to FIG. 2, FIG. 2 shows a flowchart of the display method in this embodiment.

As shown in FIG. 2, the display method comprises:

Step 201: detecting a first operation, when a display object is displayed in a first display direction in a first display position of the display unit;

Step 202: determining a second display position according to the first operation, when the first operation is a predefined operation, wherein the second display position is different from the first display position;

Step 203: acquiring a correspondence relationship between the display positions and the display directions;

Step 204: determining a second display direction corresponding to the second display position, based on the correspondence relationship between the display positions and the display directions as well as the second display position; and

Step 205: displaying the display object in the second display direction in the second display position.

In step 202, when the first operation is a predefined operation, i.e., an operation of adjusting the display position of the display object from the first display position to a second display position, the second display position is determined based on the first operation, which specifically is: if an absolute-positioning input device (e.g., a touch screen) is used, and a user directly drags the display object on the touch screen to a second display position, then the first operation comprises absolute-position parameters, and therefore the second display position can be determined just based on the absolute-position parameters.

In another embodiment, if a relative-positioning input device (e.g. a mouse and a keyboard) is used, and the display object is moved to a second position through the first operation, then in this case, the first operation comprises relative-position parameters, and therefore the second display position will be determined based on the first display position and the relative-position parameters.

In step 203, a correspondence relationship between display positions and display directions is acquired. Below, the correspondence relationship between display positions and display directions will be explained with respective examples. In the following embodiments, the display object is merely described as an picture by way of example, and in practical applications it can be any other acquainted objects, such as windows, icons, etc.

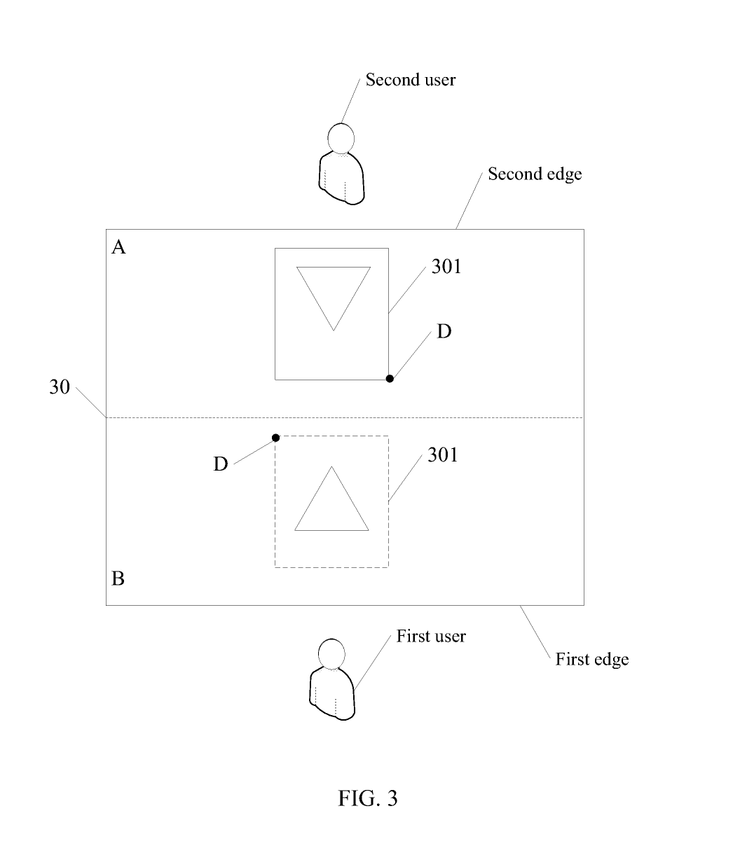

In the first embodiment, with reference to FIG. 3, a display unit 30 is divided into two display regions, i.e. a display region A and a display region B, moreover, the display region A and the display region B do not overlap; if a display object (e.g., an picture 301) is located in the display region B, the display direction is a positive direction for the first user, that is, the bottom of the picture 301 is close to the first edge of the display unit 30; if the picture 301 is located in the display region A, the display direction is a reverse direction for the first user, but a positive direction for the second user who locates beside the second edge, that is, the bottom of the picture 301 is close to the second edge of the display unit 30, wherein the first and second edges are two opposite edges; therefore, when the first user or the second user moves the picture 301 from the display region B to the display region A, the display direction of the picture is adjusted to a direction suitable for the second user to watch.

Certainly, as long as the display position is in the display region A, the display direction is always presented as a positive direction relative to the second edge; as long as the display position is in the display region B, the display direction is always presented as a positive direction relative to the first edge. In this embodiment, judging which display region the picture 301 is located in is accomplished by detecting the coordinates of the vertex D on the upper-left corner of the picture 301: if the coordinates of the vertex D are located in the display region B, then it is determined that the picture 301 is located in the display region B; similarly, if the coordinates of the vertex D are located in the display region A, it is determined that the picture 301 is located in the display region A. Then, the picture 301 is displayed on the display unit 30 with a display direction corresponding to the display region A or to the display region B. In other embodiments, the judgment also can be done by using other vertex coordinates or center coordinates, without limitation in the invention.

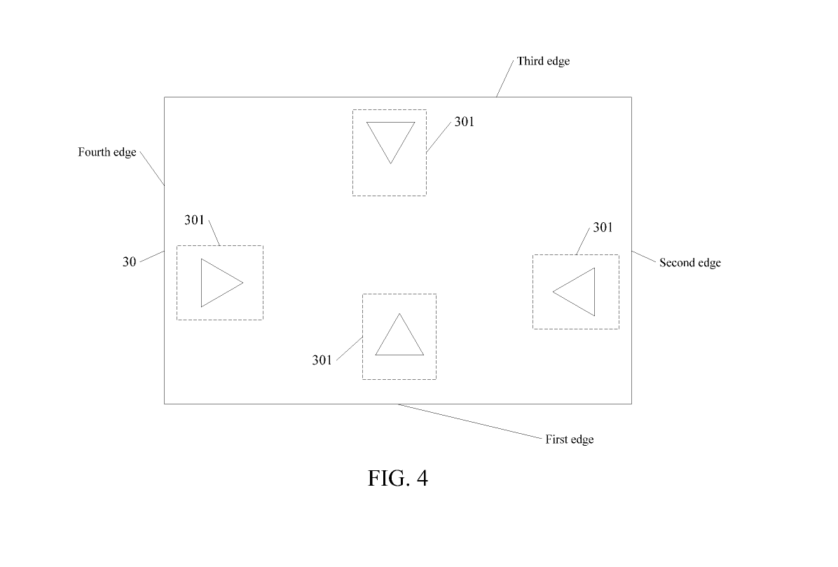

With reference to FIG. 4, FIG. 4 is a schematic diagram showing a correspondence relationship between a display object and display directions in a second embodiment of the present invention.

As shown in FIG. 4, in this embodiment, the display unit 30 comprises four edges; in other embodiments, the display unit 30 may comprise other number of edges, and the edges may be straight-line-shaped, and also may be curved. When the picture 301 is located in the edge region corresponding to the first edge of the display unit 30, the picture 301 is displayed in a positive direction relative to the first edge; when the picture is moved and located in the edge region corresponding to the second edge, then the picture 301 is displayed in a positive direction relative to the second edge; when the picture 301 is moved and located in the edge region corresponding to the third edge, then the picture 301 is displayed in a positive direction relative to the third edge; when the picture is moved and located in the edge region corresponding to the fourth edge, then the picture 301 is displayed in a positive direction relative to the fourth edge. In this embodiment, the picture 301 is displayed in a positive direction relative to a certain edge, which refers to: the bottom of the picture 301 is close to that edge, namely, the direction radiating from the center of the display unit 30 to the corresponding edge region; thus, the users who locate on that edge can see a positive image of the picture 301.

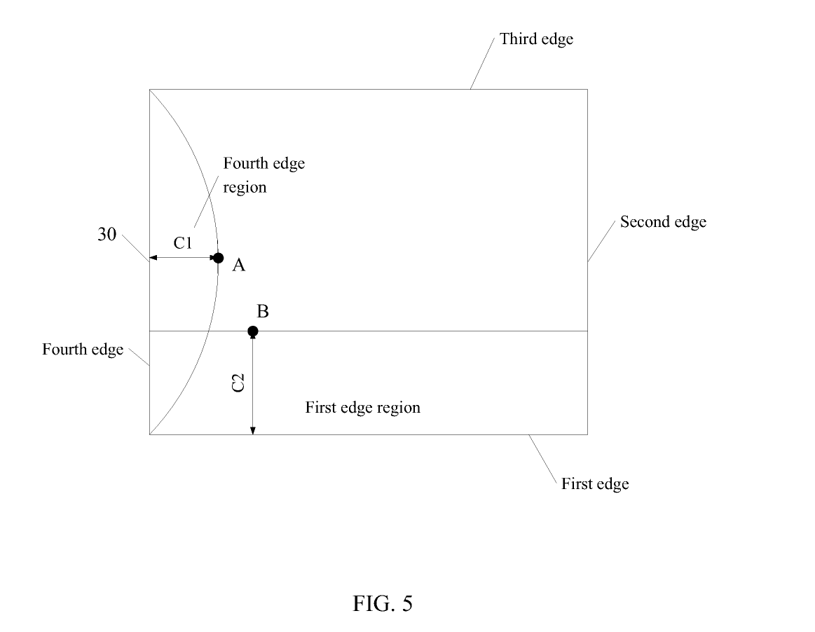

In this embodiment, an edge region corresponding to a certain edge, for example refers to: a region consisting of that edge and a straight line or an arc where a reference pixel of the display unit 30 exists, when the vertical distance from the coordinates of the reference pixel to that edge is equal to a predefined threshold value, and in the edge region, the vertical distances from the coordinates of all pixels to that edge are less than or equal to the vertical distance from the coordinates of the reference pixel to that edge. As shown in FIG. 5, the fourth edge region is a region consisting of the fourth edge and the arc where a reference pixel A exists. The vertical distance C1 from the reference pixel A to the fourth edge, for example, is 4 inches, and the vertical distances from other pixels located within the fourth edge region to the fourth edge are all less than 4 inches. Still with reference to FIG. 5, the first edge region is a region between the first edge and a straight line where the reference pixel B exists. The vertical distance C2 from the reference pixel B to the first edge, for example, is 5 inches, and the vertical distances from other pixels located within the first edge region to the first edge are all less than or equal to 5 inches. Certainly, in another embodiment, the edge region can be sufficiently small so that the edge region only comprises the edge itself, that is, the reference point overlaps with the edge.

Further, it can be seen from FIG. 5, the first edge region and the fourth edge region has an overlap portion. As for the assignment of the pixels within the overlap region, it can be determined depending on the calculation of the vertical distances from the pixel to the first edge and the fourth edge respectively; if the pixel is more closer to one edge, that is, the vertical distance from the pixel to one edge is smaller, then it is determined that the pixel is assigned to an edge region corresponding to that edge; if the distance is equal, then the pixel is assigned to one of the two edge regions through a random determination. Certainly, the skilled in the art can also set other rules to determine the assignment of the pixels in the overlap region.

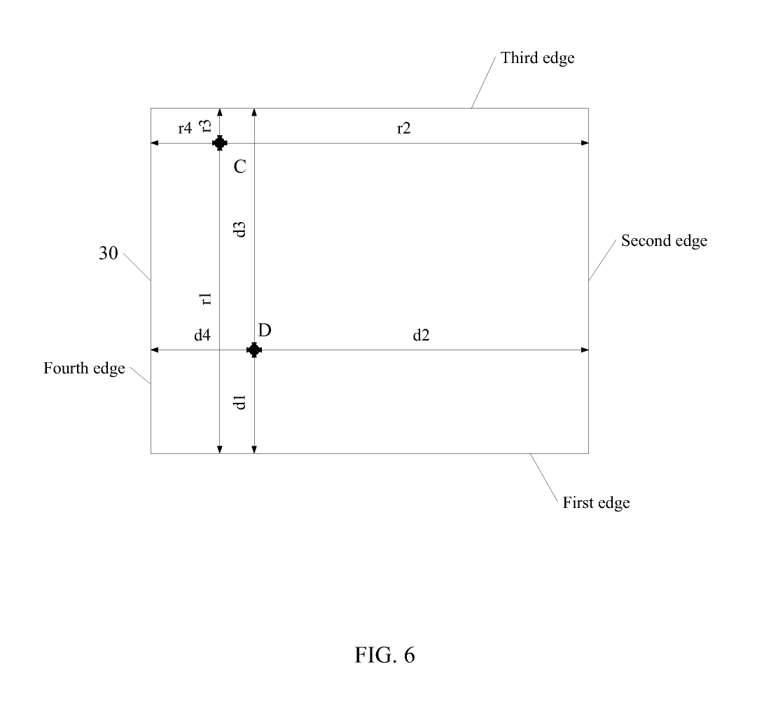

Accordingly, in this embodiment, whether or not the picture 301 is located in an edge region can be determined simply by the following steps: detecting the coordinate values of the four vertices of the picture 301; calculating vertical distances from each vertex to each edge, respectively; comparing each of the calculated distance values, and obtaining a minimum distance value among them; judging whether the minimum distance value is less than or equal to a threshold value, if yes, it is determined that the picture 301 is located in an edge region where the edge corresponding to the minimum distance value exists. In another embodiment, it also may adopt the method shown in FIG. 6: acquiring a pixel C where the first operation last stops; calculating the vertical distances r1, r2, r3, r4 from the pixel C to each of the edges; comparing each of the calculated distance values, that is, comparing r1, r2, r3, r4, and obtaining a minimum value in these distance values, in this embodiment, r3 is the minimum value; further, judging whether or not the minimum value is less than or equal to a predefined threshold value, that is, in this embodiment, judging if r3 is less than or equal to a predefined threshold value; if yes, the it can be determined that the picture 301 is located in an edge region where the edge corresponding to the minimum value exists, that is, in this embodiment, the picture 301 is located in an edge region corresponding to the third edge; if no, then it indicates that the second display position is not in an edge region, and therefore the display direction will not be changed.

Certainly, it is possible that there exist pixels such as the pixel D in FIG. 6. With calculation, it is found that, the distance values d4 and d1 are equal, in this case, it is determined by the following steps: firstly, judging whether both d4 and d1 are less than or equal to the predefined threshold value defined for the respective edge region; if d4 is greater than the predefined threshold value, while dl is equal to the predefined threshold value, it is determined that the pixel D is located in the edge region corresponding to the first edge; if d4 is less than the predefined threshold value, while dl is greater than the predefined threshold value, it is determined that the pixel D is located in the edge region corresponding to the fourth edge; if d4 is greater than the predefined threshold value, and d1 is also greater than the predefined threshold value, it is determined that the pixel D is not in the two edge regions; if d4 is less than or equal to the predefined threshold value, and d1 is less than or equal to the predefined threshold value, it can be determined randomly that the pixel D is located in one of the two edge regions, also it may combine with other determination conditions to determine which edge region the pixel D belongs, for example by detecting the user's location. Thus, it can further determine whether the second display position is in an edge region.

In addition, in another embodiment, as mentioned before, if an edge region is the edge itself, then only when the vertex of the picture 301 close to that edge is in contact with that edge or beyond that edge, it can be determined that the picture 301 is located in that edge region.

Finally, according to the second display position of the picture 301 and a correspondence relationship between display positions and display directions as shown in FIG. 4, a second display direction corresponding to the second display position is obtained, and the display object is displayed in accordance with the second display direction. Thus, users who locate at a corresponding edge can watch a positive image of the display object, which brings convenience to users.

In another embodiment, except the above-described edge regions, the other region is called a central region. When the picture 301 is in the center region, it can be displayed in an arbitrary direction, for instance, displayed randomly or displayed in a default display direction; when the picture 301 is moved from the central region to an edge region, if the current display direction is just the display direction corresponding to that edge region, then it is displayed in accordance with the current display direction, and not triggered to rotate; if the current display direction is different from the display direction corresponding to that edge region, then it is triggered to rotate, so that the picture 301 is displayed in the display direction corresponding to that edge region.

In the above embodiments, whether there is a change in the display position of the display object 301, is judged by: determining whether or not the corresponding coordinates of the vertices in the first display position and in the second display position are the same. If different, then it is determined that the position is changed; if same, then it is determined that the display position is not changed. Certainly, other point coordinates of the display object than the center point also may be used for the judgment.

Another embodiment of the present invention further provides a display apparatus, for realizing the aforementioned display method.

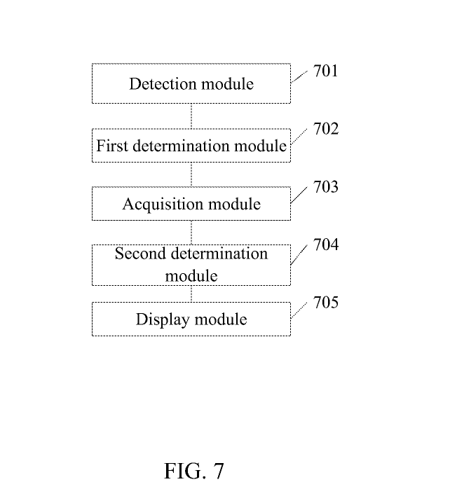

As shown in FIG. 7, the display apparatus comprises:

A detection module 701, used for detecting a first operation, when a display object is displayed in a first display direction in a first display position of the display unit; a first determining module 702, used for determining a second display position according to the first operation, when the first operation is a predefined operation, wherein the second display position is different from the first display position; an acquisition module 703, used for acquiring a correspondence relationship between the display positions and the display directions; a second determining module 704, used for determining a second display direction corresponding to the second display position, based on the correspondence relationship between the display positions and the display directions as well as the second display position; and a display module 705, for displaying the display object in the second display direction in the second display position.

The display unit comprises at least a first display region and a second display region, and the first display region and the second display region do not overlap; wherein, all display positions in the first display region correspond to the first display direction; all display positions in the second display region correspond to the second display direction; the first display direction is different from the second display direction.

Further, the first determining module 702 is also used for: determining a second display position according to the first display position and relative-position parameters, when the first operation is a predefined operation and the first operation comprises relative-position parameters.

In another embodiment, the first determining module 702 is also used for: determining a second display position according to absolute-position parameters, when the first operation is a predefined operation and the first operation comprises absolute-position parameters.

When the second display position is located in such an edge region as described above, the second determining module 704 is also used for: determining that the second display direction is a direction radiating from the center of the display unit to the edge region.

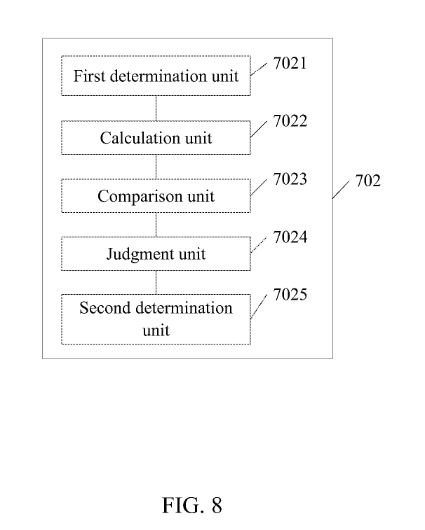

In another embodiment, a first determining module 702 is used for determining whether or not the second display position is located in an edge region. As shown in FIG. 8, the first determining module 702 comprises: a first determination unit 7021, used for determining a pixel where the first operation last stops on the display unit, based on the first operation; a calculation unit 7022, used for calculating the vertical distance values from the pixel to each of the edges of the display unit, and obtaining a number N of distance values, where N is an integer equal to or greater than 3; a comparison unit 7023, used for comparing the number N of distance values, and obtaining a minimum distance value in the number N of distance values; a judgment unit 7024, used for judging whether or not the minimum distance value is less than the predefined threshold value; and a second determination unit 7025, used for determining that the second display position is in the edge region of the edge corresponding to the minimum distance value, when the minimum distance value is less than the predefined threshold value.

A number of variations in the above-described display method are also applicable to the display apparatus of this embodiment. From the above detailed description of the display method, the skilled in the art can clearly understand implementations of the display apparatus in this embodiment, and therefore, for the sake of brevity, a detailed description of which is omitted.

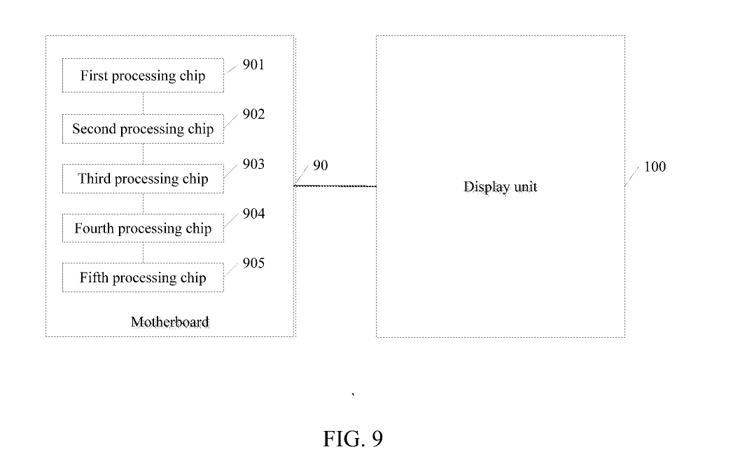

Further another embodiment of the present invention provides an electronic terminal. With reference to FIG. 9, FIG. 9 is an architectural diagram of an electronic terminal in accordance with this embodiment.

As shown in FIG. 9, the electronic terminal comprises: a display unit 100; a motherboard 90, electrically connected with the display unit 100; a first processing chip 901, provided on the motherboard 90, and used for detecting a first operation, when a display object is displayed in a first display direction in a first display position of the display unit 100; a second processing chip 902, provided on the motherboard 90, and used for determining a second display position according to the first operation, when the first operation is a predefined operation, wherein the second display position is different from the first display position; a third processing chip 903, provided on the motherboard 90, and used for acquiring a correspondence relationship between the display positions and the display directions; a fourth processing chip 904, used for determining a second display direction corresponding to the second display position, based on the correspondence relationship between the display positions and the display directions as well as the second display position; and a fifth processing chip 905, used for displaying the display object in the second display direction in the second display position; wherein, any two chips from the first processing chip 901, the second processing chip 902, the third processing chip 903, the fourth processing chip 904 and the fifth processing chip 905, are the same chips or mutually-independent chips.

A number of variations in the above-described display method are also applicable to the electronic terminal of this embodiment. From the above detailed description of the display method, the skilled in the art can clearly understand implementations of the electronic terminal in this embodiment, and therefore, for the sake of brevity, a detailed description of which is omitted.

An embodiment of the present invention adopts a method of determining a corresponding display direction depending on different display positions, so that users who locate in different directions can watch a display object from a comfortable viewpoint.

Further, an embodiment of the present invention sets as follows: a display object is displayed in a same display direction when it is in a fixed region, and in different display directions when it is in different regions, so that users who locate in different regions or directions can watch a display object conveniently.

Furthermore, in an embodiment of the present invention, when a display object is moved to an edge region of the display unit, its display direction will be switched automatically to a display direction adapted to a corresponding edge of that edge region, namely, a direction radiating from the center of the display unit to that edge region, so that users who locate on each edge can watch the display object from an optimum angle.

Apparently, a variety of variations and modifications can be made to the present invention by the skilled in the art, without departing from the spirit and scope of the present invention. Accordingly, insofar as these variations and modifications of the present invention are within the scope of the appended claims of the invention and their equivalents, the present invention should also be intended to include these variations and modifications.

What is claimed is:

1. A display method, applied in an electronic terminal comprising a display unit, characterized in that, the method comprising:
detecting a first operation, when a display object is displayed along a first display direction at a first display position of the display unit;
determining a second display position according to the first operation, when the first operation is a predefined operation, whereat the second display position is different from the first display position;
acquiring a correspondence relationship between the display positions and the display directions;
determining a second display direction corresponding to the second display position, based on the correspondence relationship between the display positions and the display directions as well as the second display position; and
displaying the display object along the second display direction at the second display position.

2. The method according to claim 1, characterized in that, the display unit comprises at least a first display region and a second display region, and the first display region and the second display region do not overlap; wherein, all display positions in the first display region correspond to the first display direction; all display positions in the second display region correspond to the second display direction; the first display direction is different from the second display direction.

3. The method according to claim 1, characterized in that, determining a second display position according to the first operation when the first operation is a predefined operation comprises: determining a second display position according to absolute-position parameters, when the first operation is a predefined operation and the first operation comprises the absolute-position parameters.

4. The method according to claim 1, characterized in that, determining a second display position according to the first operation when the first operation is a predefined operation comprises: determining a second display position according to the first display position and relative-position parameters, when the first operation is a predefined operation and the first operation comprises the relative-position parameters.

5. The method according to claim 1, characterized in that, the second display position is located in an edge region corresponding to an edge of the display unit, wherein the edge region is a region consisting of that edge and a straight line or an arc where a reference pixel of the display unit exists, and wherein a vertical distance from the reference pixel to that edge is equal to a predefined threshold value, and the vertical distances from all pixels in the edge region to that edge is less than or equal to the predefined threshold value.

6. The method according to claim 5, characterized in that, when the second display position is located within the edge region, the second display direction is a direction radiating from the center of the display unit to the edge region.

7. The method according to claim 5, characterized in that, whether or not the second display position is located within the edge region, is determined by the following steps:
determining a pixel where the first operating last stops on the display unit, based on the first operation;
calculating the vertical distance values from the pixel to each of the edges of the display unit, and obtaining a number N of distance values, where N is an integer equal to or greater than 3;
comparing the number N of distance values, and obtaining a minimum distance value in the number N of distance values;
determining whether or not the minimum distance value is less than the predefined threshold value; and
determining that the second display position is the edge region of the edge corresponding to the minimum distance value, when the minimum distance value is less than the predefined threshold value.

8. The method according to claim 1, characterized in that, the second display position is different from the first display position, which specifically is: the corresponding coordinates of the vertices of the display object at the first display position and at the second display position are different.

9. A display apparatus, applied to an electronic terminal comprising a display unit, characterized in that, the apparatus comprises:
a detecting module, used for: detecting a first operation, when a display object is displayed along a first display direction at a first display position of the display unit;
a first determination module, used for: determining a second display position according to the first operation, when the first operation is a predefined operation, whereat the second display position is different from the first display position;
an acquisition module, used for: acquiring a correspondence relationship between the display positions and the display directions;
a second determination module, used for: determining a second display direction corresponding to the second display position, based on the correspondence relationship between the display positions and the display directions as well as the second display position; and
a display module, used for: displaying the display object along the second display direction at the second display position.

10. The apparatus according to claim 9, characterized in that, the display unit comprises at least a first display region and a second display region, and the first display region and the second display region do not overlap; wherein, all display positions in the first display region correspond to the first display direction; all display positions in the second display region correspond to the second display direction; the first display direction is different from the second display direction.

11. apparatus according to claim 9, characterized in that, the first determination module is also used for: determining a second display position according to the absolute-position parameters, when the first operation is a predefined operation and the first operation comprises absolute-position parameters.

12. The apparatus according to claim 9, characterized in that, the first determination module is also used for: determining a second display position according to the first display position and the relative-position parameters, when the first operation is a predefined operation and the first operation comprises relative-position parameters.

13. The apparatus according to claim 9, characterized in that, the second display position is located in an edge region corresponding to an edge of the display unit, wherein the edge region is a region consisting of that edge and a straight line or an arc where a reference pixel of the display unit exists, and wherein a vertical distance from the reference pixel to that edge is equal to a predefined threshold value, and the vertical distances from all pixels in the edge region to that edge is less than or equal to the predefined threshold value.

14. The apparatus according to claim 13, characterized in that, when the second display position is located within the edge region, the second determination module is also used for: determining that the second display direction is a direction radiating from the center of the display unit to the edge region.

15. The apparatus according to claim 13, characterized in that, the first determination module is also used for: determining whether or not the second display position is located within the edge region, the first determination module comprising:
a first determination unit, used for: determining a pixel where the first operating last stops on the display unit, based on the first operation;
a calculation unit, used for: calculating the vertical distance values from the pixel to each of the edges of the display unit, and obtaining a number N of distance values, where N is an integer equal to or greater than 3;
a comparison unit, used for: comparing the number N of distance values, and obtaining a minimum distance value in the number N of distance values;
a judgment unit, used for: judging whether or not the minimum distance value is less than the predefined threshold value; and
a second determination unit, used for: determining that the second display position is the edge region of the edge corresponding to the minimum distance value, when the minimum distance value is less than the predefined threshold value.

16. The apparatus according to claim 9, characterized in that, the second display position is different from the first display position, which specifically is: the corresponding coordinates of the vertices of the display object at the first display position and at the second display position are different.

17. An electronic terminal, characterized in that, the electronic terminal comprises:
a display unit;
a motherboard, electrically connected with the display unit;
a first processing chip, provided on the motherboard, and used for: detecting a first operation, when a display object is displayed along a first display direction at a first display position of the display unit;
a second processing chip, provided on the motherboard, and used for: determining a second display position according to the first operation, when the first operation is a predefined operation, whereat the second display position is different from the first display position;
a third processing chip, provided on the motherboard, and used for: acquiring a correspondence relationship between the display positions and the display directions;
a fourth processing chip, used for: determining a second display direction corresponding to the second display position, based on the correspondence relationship between the display positions and the display directions as well as the second display position; and
a fifth processing chip, used for: displaying the display object along the second display direction at the second display position;
wherein, any two chips from the first processing chip, the second processing chip, the third processing chip, the fourth processing chip and the fifth processing chip, are the same chips or mutually-independent chips.
